(19) United States
(12) Patent Application Publication
(10) Pub. No.: US 2012/0116030 A1
(43) Pub. Date: May 10, 2012

(54) PROCESS FOR CONTINUOUSLY PRODUCING THERMOPLASTICALLY PROCESSABLE POLYURETHANES

(75) Inventors: Jens HEPPERLE, Koln (DE); Ulrich LIESENFELDER, Bergisch Gladbach (DE); Wolfgang BRÄUER, Leverkusen (DE); Wolfgang KAUFHOLD, Koln (DE); Achim HÄSELER, Leverkusen (DE)

(73) Assignees: Bayer MaterialScience AG, Leverkusen (DE); Bayer Technology Services GmbH, Leverkusen (DE)

(21) Appl. No.: 13/291,228

(22) Filed: Nov. 8, 2011

(30) Foreign Application Priority Data
Nov. 10, 2010 (DE) 10 2010 050 780.6

(51) Int. Cl. C08G 18/08; C08G 18/66

(52) U.S. Cl. 526/67

(57) ABSTRACT

The invention relates to a process for continuously producing thermoplastically processable polyurethanes in a recycle reactor with flexibly adjustable mixing conditions.

The invention relates to a process for continuously producing thermoplastically processable polyurethanes in a recycle reactor with flexibly adjustable mixing conditions.

Thermoplastic elastomers (TPEs) are of great technical interest because they combine the mechanical properties of vulcanized elastomers (“rubber”) with the processability of thermoplastics. The ability of TPEs to undergo repeated melting and repeated processing is based on the absence of the chemical crosslinking sites present in rubber.

Thermoplastic polyurethane elastomers (TPUs) are a type of TPE and have been known for a long time. TPUs obtain their elastomeric properties via a constitution made of hard and soft blocks. The hard segments form domains which function as physical crosslinking sites. The structure of the TPUs gives, in comparison with crosslinked elastomers, lower heat resistance and less resilience on removal of load, and these can be advantageous in certain applications. A factor which is always advantageous is, in comparison with crosslinked elastomers, lower-cost processing due to shorter cycle times, and recyclability.

A wide variety of mechanical properties can be achieved via use of different chemical structural components. An overview of TPUs, and their properties and applications is found by way of example in the following publications: Kunststoffe 68 (1978), pages 819 to 825 or Kautschuk, Gummi, Kunststoffe 35 (1982), pages 568 to 584.

TPUs are generally composed of linear polyols, mostly of polyester polyols or of polyether polyols, and of organic diisocyanates and of short-chain diols. The soft segments produced from the reaction between diisocyanate and polyol function as elastic components when mechanical stress is applied. The hard segments (urethane groups) serving as crosslinking sites are obtained via reaction of the diisocyanate with a low-molecular-weight diol for chain-extension purposes.

The molar ratios of the structural components can be varied relatively widely in order to adjust physical properties. Molar ratios of polyols to chain extenders (diols) of from 1:1 to 1:12 have proved successful. These give products with Shore hardness in the range from 70 Shore A to 75 Shore D (see the standards DIN 53505 and DIN 7868 for the definition and measurement of Shore hardness).

Polyurethane prepolymers or TPUs are usually produced by using a catalyst which remains within the product, where it can have an adverse effect on the properties thereof. It would therefore be desirable to reduce catalyst content in the product.

The thermoplastically processable polyurethane elastomers can be synthesized either stepwise (prepolymer feed process) or via simultaneous reaction of all of the components in one stage (One-Shot feed process). TPUs can be produced continuously or batchwise.

The literature (see, for example, DE2823762A1) discloses production processes in which the starting materials are first mixed in a mixing zone at low temperatures at which no polyaddition occurs, and then react with one another in a reaction zone which has the desired reaction temperature. The mixing zone and reaction zone are preferably provided via static mixers. Homogeneous products are obtained.

There are also known processes in which the mixing of the starting materials takes place after reaction conditions have been established. By way of example, EP1055691B1 describes a continuous process for producing TPU by mixing the starting materials homogeneously in a “One-Shot feed process” into a first static mixer with a shear rate from 500 s⁻¹ to 50 000 s⁻¹ within at most 1 second. The conversion achieved in the first static mixer is >90%. There can be a second static mixer downstream of the first static mixer.

DE102005004967A1 proposes, for production of TPU, feeding the starting materials into a self-cleaning twin-screw extruder, which is operated at high shear rates. Disadvantages are, in comparison with the use of static mixers as reactors, reduced mixing action and heat dissipation in twin-screw extruders.

The physical properties of TPUs, and in particular their mechanical properties, are very important during their processing and use. By way of example, softening behaviour is important in the case of hot-melt foils, and sinter products, or else when thermal loads are high, for example in the soldering of plastic substrates. Softening behaviour can be characterized via heat-distortion temperatures. These are temperatures at which a test specimen deforms when exposed to an exterior force, as far as a limiting value. Various methods can be used to determine heat distortion, examples being the Vicat method (DIN EN ISO 306) or the method of DIN EN ISO 75.

There is a constant requirement for novel materials which have properties optimized for certain applications.

EP1068250B1 describes a process for producing TPUs where the products have softening behaviour which is advantageous for many applications; in particular, they feature a low softening point. In the process described, the starting materials are first mixed intensively with the aid of a static mixer and the mixture is then reacted in an extruder to give the TPU. A disadvantage of the said process is the use of an extruder which incurs high costs and demands a high level of maintenance.

It was an object of the present invention to provide a simplified process for the continuous production of TPUs with a low softening point. The required process should be flexible in relation to the starting materials used. Another object was to formulate the operating parameters (such as throughput, flow rates, temperatures of starting materials, temperature of ancillary heating system, average residence time) in such a way that the polymerization process proceeds smoothly and gives a high-quality product. Another object was to provide TPUs with catalyst content reduced in comparison with the prior art.

Surprisingly, it has been found that TPUs with lower softening point can be produced when the reaction is carried out in a recycle reactor which comprises a mixing apparatus and an apparatus for returning the reaction mixture from the outgoing end of the mixing apparatus to the ingoing end of the mixing apparatus. Surprisingly, it is not necessary to use an extruder as described in the prior art.

Surprisingly, it has moreover been found that the use of catalysts can be reduced during the production of TPUs if, after passage through a mixing apparatus, a portion of the reaction mixture is returned into the ingoing stream of the mixing apparatus.

The invention therefore provides a process for continuously producing thermoplastically processable polyurethane elastomers with improved softening behaviour and/or with reduced catalyst content, where
a component A which comprises one or more polyisocyanates, and
a component B which has hydrogen atoms that have Zerevitinov activity and which comprises
   B1: from 1 to 85 equivalent%, based on the isocyanate groups in A, of one or more compounds which have, per molecule, at least one 1.8 and at most 2.2 hydrogen atoms that have Zerevitinov activity, and which have an average molar mass M̅ₙ of from 450 to 5000 g/mol, and
   B2: from 15 to 99 equivalent%, based on the isocyanate groups in A, of one or more chain extenders which have, per molecule, at least one 1.8 and at most 2.2 hydrogen atoms that have Zerevitinov activity, and which have a molar mass of from 60 to 400 g/mol,
and also from 0 to 20% by weight, based on the total amount of TPU, of further auxiliaries and additives C,
where the NCO/OH ratio of components A and B used is from 0.9:1 to 1.1:1, are reacted in a recycle reactor, where the recycle reactor comprises at least one inlet, one mixing apparatus, one outlet, and means for returning a portion of the reaction mixture from the outgoing end of the mixing apparatus to the ingoing end of the mixing apparatus.

For the purposes of the invention, continuous reactions are those in which the inflow of the starting materials into the reactor and the discharge of the products from the reactor take place simultaneously but at separate locations, whereas in the case of batchwise reaction the reaction has a chronological sequence: inflow of the starting materials, chemical reaction and discharge of the products. The continuous mode of operation is economically advantageous, since it avoids reactor downtime which is a consequence of charging and discharge processes and long reaction times which are a consequence of safety regulations, reactor-specific heat exchange rates, and also the heating and cooling involved in batch processes.

The process according to the invention is characterized in that the reaction between the starting materials (A, B, optionally C) takes place in a reactor which comprises at least the following units: an inlet, a mixing apparatus, an outlet, and means for returning a portion of the reaction mixture from the outgoing end of the mixing apparatus to the ingoing end of the mixing apparatus. This type of reactor is also termed recycle reactor here.

The mixing apparatus is preferably a static mixer or an arrangement of a plurality of static mixers. Whereas in the case of dynamic mixers the homogenization of a mixture is achieved via moving units such as stirrers, static mixers utilize the energy in the flow of a fluid: a conveying unit (e.g. a pump) forces the fluid (gas or liquid) through a tube provided with static mixer internals, whereupon the fluid proceeding along the main flow axis is divided into substreams which, as a function of the nature of the internals, are mixed and combined in vortices. An overview of the various types of static mixers used in conventional process technology is given by way of example in the article “Statische Mischer und ihre Anwendungen” [Static mixers and their applications], M. H. Pahl and E. Muschelknautz, Chem.-Ing.-Techn. 52 (1980) No. 4, pp. 285-291.

Static mixers that can be used according to the invention are described in Chem.-Ing. Techn. 52, No. 4, pages 285 to 291, and also in “Mischen von Kunststoff und Kautschukprodukten” [Mixing of Plastic and Rubber Products], VDI-Verlag, Dusseldorf 1993. It is preferable to use the mixers with crossed bars described in DE2532355A1. By way of example, SMX static mixers from Sulzer may be mentioned. It is particularly preferable to use static mixers which divide the cross section into two channels which narrow to half of the cross section and then widen again to the full cross section, with 90° displacement between the entry and discharge channels. The person skilled in the art terms these mixers “cascade mixers” or “multiflux mixers” (Sluijters De Ingenieur 77 (1965), 15, pp. 33-36).

Other suitable static mixers are those such as SMV or SMXL (Sulzer Chemtech), Kenics (Chemineer Inc.) or what are known as Interfacial Surface Generators (ISG) and Low Pressure Drop Mixers (Ross Engineering Inc). Other suitable mixers are those with integrated heat exchanger, e.g. SMR from Sulzer or CSE-XR mixers from Fluitec (disclosed by way of example in: EP 1067352 A1 or Verfahrenstechnik 35 (2001) No. 3, 48-50) or by means of mixers/heat exchangers (disclosed, for example, in EP1384502 (B1)).

It is also possible to use a static-mixer cascade as mixing apparatus, instead of a single static mixer. A static-mixer cascade is a serial arrangement of two or more static mixers of identical or different type, where their geometry differs by virtue of the type of mixer or by virtue of dimensions, e.g. their diameter, or the width of the mixing bars. It is also possible to arrange a plurality of static mixers or static-mixer cascades in parallel, for example in order to increase the mass flow rate. The mass flow rate increases here by a factor which corresponds to the number of static mixers or static-mixer cascades arranged in parallel. The term a static mixer is therefore used hereinafter to mean a single static mixer, a single static-mixer cascade, a plurality of individual static mixers arranged in parallel or a plurality of static-mixer cascades arranged in parallel. The static-mixer cascade can take the form of tubes arranged in parallel, e.g. as in a heat exchanger (described in EP0087817A1) or can take the form of an apparatus in which the flow channels have parallel arrangement.

The mixing apparatus has at least one ingoing end and one outgoing end, i.e. the components to be mixed can be introduced into the mixing apparatus by way of a shared inlet or separately by way of a plurality of separate inlets. The liquid components are introduced through tubes attached upstream of the mixing apparatus; as an alternative, the components can also be introduced into a T-piece or predistribution system, before they pass through the mixing apparatus.

Downstream of the mixing apparatus, a portion of the outgoing stream from the mixing apparatus is returned to the ingoing end of the mixing apparatus. This is achieved by way of example by using a circulating pump. The amount returned is termed returned volume flow rate \dot{V}_{R}.

The mixing achieved in the mixing apparatus is influenced by the volume flow rate of all of the fresh components introduced and also by the volume flow rate of the returned reaction mixture. The shear rates at the walls of the static recycle mixers can be influenced by way of the returned volume flow rate.

The recycle reactor is characterized by the recycle ratio f:

$$f = \frac{( {\dot{V}}_{R} + {\dot{V}}_{tot} )}{{\dot{V}}_{tot}} = \frac{{\dot{V}}_{2}}{{\dot{V}}_{tot}}$$

\dot{V}₀ here designates the total volume flow rate, i.e. the sum of all of the volume flow rates of the starting materials A, B and C, i.e. \dot{V}ₜₒₜ=\dot{V}_{A}+\dot{V}_{B}+\dot{V}_{C}. The volume flow rate passing through the mixing apparatus (2) within the circuit is a returned volume flow rate \dot{V}_{R} plus the total volume flow rate \dot{V}ₜₒₜ, i.e. \dot{V}₂=\dot{V}_{R}+\dot{V}ₜₒₜ. The recycle ratio is defined as the ratio of the volume flow rate \dot{V}₂ , to the total volume flow rate \dot{V}ₜₒₜ.

For SMX static mixers, the shear rate is calculated, in the form of representative shear rate at the walls, by way of the following relationship known to the person skilled in the art:

$$\dot{γ} = 8 \frac{4 \cdot \dot{V}}{π \cdot {D}^{3}}$$

\dot{γ} designates the representative shear rate at the walls, \dot{V} designates the volume flow rate, and D designates the internal diameter of the tube. π it is the ratio of a circle's circumference to its radius (π≈3.14159265). The shear rate here is proportional to the volume flow rate. The shear rate in the mixers within the circuit can therefore also be varied by way of the recycle ratio.

The recycle ratio f during operation of the recycle reactor is in the range from 1 to 150, preferably in the range from 1.2 to 50, particularly preferably in the range from 1.3 to 20, very particularly preferably in the range from 1.4 to 8.

During operation of the recycle reactor, the static mixers used in the circuit are characterized by shear rates at the walls in the range from 100 s⁻¹ to 50 000 s⁻¹, preferably from 200 s⁻¹ to 20 000 s⁻¹, particularly preferably from 400 s⁻¹ to 10 000 s⁻¹, very particularly preferably from 500 s⁻¹ to 6000 s⁻¹. The total residence time in the said static mixers is in the range from 0.1 s to 30 s, particularly preferably from 0.2 s to 10 s, very particularly preferably from 0.3 s to 5 s. The static mixers have been designed with thermal insulation, or have preferably been heated to from 200° to 280° C., and have a length/diameter ratio of from 4:1 to 60:1, preferably from 8:1 to 40:1, particularly preferably from 8:1 to 20:1.

When the recycle reactor is in operation it is preferably charged hydraulically, so that the mass flow rates at all of the inlets and those at the outlet are identical during stationary-state operation.

It is possible to add further static mixers in the direction of flow upstream of and/or downstream of the recycle mixing apparatus. In one preferred embodiment, the recycle mixing apparatus is followed in the direction of flow by a static mixer which has been designed on the principles familiar to the person skilled in the art in such a way as to ensure cooling of the reacting composition within a few seconds, preferably within 10 s. The cooling preferably takes place to <300° C., particularly preferably to <280° C. and very particularly preferably to <260° C.

All of the static mixers used in the process can have been introduced into a heated or cooled apparatus system.

The mixing in the static mixers which are not within the circuit is characterized by a shear rate at the walls in the range from 50 s⁻¹ to 20 000 s⁻¹, preferably from 100 s⁻¹ to 10 000 s⁻¹, particularly preferably from 300 s⁻¹ to 6000 s⁻¹, very particularly preferably from 500 s⁻¹ to 4500 s⁻¹. The residence time in the said static mixers is in the range from 0.1 s to 60 s, preferably from 0.2 s to 20 s, particularly preferably from 0.3 s to 10 s, very particularly preferably from 0.5 s to 6 s. The static mixers have been designed with thermal insulation, or have preferably been heated to from 200° C. to 280° C., and have a length/diameter ratio of from 2:1 to 60:1, preferably from 5:1 to 40:1, particularly preferably from 8:1 to 20:1.

It is possible to take the mixture leaving the recycle reactor and feed it to a continuously operating kneader and/or extruder (e.g. a ZSK twin-screw kneader from Coperion). Mixing can be used here to incorporate additional liquid or solid auxiliaries into the TPU. The material is preferably pelletized at the end of the extruder.

It is also possible to take the mixture leaving the recycle reactor and introduce it into a further mixer, in order to add a liquid additive or a molten masterbatch.

In one embodiment of the process according to the invention, components A and B are heated separately from one another, preferably in a heat exchanger, to a temperature of from 170° C. to 250° C., and are fed simultaneously and continuously in liquid form into a first static mixer which is within the circuit or has been installed upstream of the same (One-Shot feed process). By this stage, B is a mixture made of B1 and B2.

In another embodiment of the process according to the invention, components B1 and B2 are not premixed. Instead of this, components A and B1 are first heated separately from one another, preferably in a heat exchanger, to a temperature of from 170° C. to 250° C., and are fed simultaneously and continuously in liquid form into a first static mixer, preferably installed upstream of the circuit. Component B2 is heated in the same way and added at another site to the reacting mixture of A and B1 (prepolymer feed process).

The feed rates of all of the components primarily depend on the desired residence times and, respectively, the conversions to be achieved. As the maximum reaction temperature increases, the residence time should become shorter. The residence time can be controlled, by way of example, via the volume flow rates and the volume of the entire reaction zone. It is advantageous to use various measurement devices to monitor the progress of the reaction. Devices for measuring temperature, viscosity, thermal conductivity and/or refractive index in fluid streams and/or for measuring (near) infrared spectra are particularly suitable for this purpose.

The components are homogeneously mixed in the static mixers within the circuit and also in the static mixers upstream of and/or optionally downstream of the circuit.

The temperature of the reaction mixture when it leaves the reactor is usually in the range from 210° C. to 300° C.

Examples of organic polyisocyanates A that can be used are aliphatic, cycloaliphatic, araliphatic, heterocyclic and aromatic diisocyanates as described by way of example in Justus Liebigs Annalen der Chemie, 562, pages 75 to 136.

Individual compounds that may be mentioned by way of example are: aliphatic diisocyanates such as hexamethylene diisocyanate, cycloaliphatic diisocyanates, such as isophorone diisocyanate, cyclohexane 1,4-diisocyanate, 1-methylcyclohexane 2,4-diisocyanate and 2,6-diisocyanate, and also the corresponding isomer mixtures, dicyclohexylmethane 4,4′-, 2,4′- and 2,2′-diisocyanate, and also the corresponding isomer mixtures, and aromatic diisocyanates such as tolylene 2,4-diisocyanate, mixtures of tolylene 2,4- and 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and/or diphenylmethane 2,4′-diisocyanates, 4,4′-diisocyanato-1,2-diphenylethane and naphthylene 1,5-diisocyanate. It is preferable to use diphenylmethane diisocyanate isomer mixtures having more than 96% by weight diphenylmethane 4,4′-diisocyanate content, and in particular diphenylmethane 4,4-diisocyanate and naphthylene 1,5-diisocyanate. The diisocyanates mentioned can be used individually or in the form of mixtures with one another. They can also be used together with up to 15% (based on total diisocyanate) of a polyisocyanate, but at most an amount that produces a thermoplastically processable product. Examples are triphenylmethane 4,4′,4″-triisocyanate and polyphenyl polymethylene polyisocyanates.

Component B1 used comprises linear hydroxy-terminated polyols which have, per molecule, an average of from 1.8 to 3.0, preferably up to 2.2, hydrogen atoms that have Zerevitinov activity, and which have a molar mass of from 450 to 5000 g/mol. The production process often causes these to comprise small amounts of nonlinear compounds. Another expression often used is therefore “polyols that are in essence linear”. Preference is given to polyester diols, polyether diols, polycarbonate diols, or a mixture of these.

Suitable polyether diols can be produced by reacting one or more alkylene oxides having from 2 to 4 carbon atoms in the alkylene moiety with a starter molecule which comprises two active hydrogen atoms. Examples that may be mentioned of alkylene oxides are: ethylene oxide, propylene 1,2-oxide, epichlorohydrin and butylene 1,2-oxide and butylene 2,3-oxide. It is preferable to use ethylene oxide, propylene oxide and mixtures of propylene 1,2-oxide and ethylene oxide. The alkylene oxides can be used individually, in alternation with one another or in the form of a mixture. Examples of starter molecules that can be used are: water, amino alcohols, such as N-alkyldiethanolamines, e.g. N-methyl-diethanolamine and diols, such as ethylene glycol, propylene 1,3-glycol, 1,4-butanediol and 1,6-hexanediol. It is also possible, if appropriate, to use a mixture of starter molecules. Other suitable polyetherols are the tetrahydrofuran-polymerization products comprising hydroxy groups. It is also possible to use proportions of from 0 to 30% by weight, based on the bifunctional polyethers, of trifunctional polyethers, but at most an amount that produces a thermoplastically processable product. The polyether diols that are in essence linear preferably have molar masses of from 450 to 5000 g/mol. They can be used either individually or else in the form of a mixture with one another.

Suitable polyester diols can by way of example be produced from dicarboxylic acids having from 2 to 12 carbon atoms, preferably from 4 to 6 carbon atoms, and from polyfunctional alcohols. Examples of dicarboxylic acids that can be used are: aliphatic dicarboxylic acids, such as succinic acid, glutaric acid, adipic acid, suberic acid, azelaic acid and sebacic acid, and aromatic dicarboxylic acids, such as phthalic acid, isophthalic acid and terephthalic acid. The dicarboxylic acids can be used individually or in the form of a mixture, e.g. in the form of a succinic, glutaric and adipic acid mixture.

For production of the polyester diols it can, if appropriate, be advantageous to use, instead of the dicarboxylic acids, the corresponding dicarboxylic acid derivatives, such as carboxylic diesters having from 1 to 4 carbon atoms in the alcohol moiety, carboxylic anhydrides or acyl chlorides. Examples of polyfunctional alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol and dipropylene glycol. As a function of the properties desired, the polyfunctional alcohols can be used alone or, if appropriate, in a mixture with one another.

Other suitable compounds are esters of carboxylic acid with the diols mentioned, in particular those having from 4 to 6 carbon atoms, e.g. 1,4-butanediol and/or 1,6-hexanediol, condensates of ω-hydroxycarboxylic acids, such as ω-hydroxycapronoic acid, and preferably polymerization products of lactones, examples being optionally substituted ω-caprolactones. Polyester diols preferably used are ethanediol polyadipates, 1,4-butanediol polyadipates, ethanediol 1,4-butanediol polyadipates, 1,6-hexanediol neopentyl glycol polyadipates, 1,6-hexanediol 1,4-butanediol polyadipates and polycaprolactones. The molar masses of the polyester diols are from 450 to 5000 g/mol and they can be used individually or in the form of a mixture with one another.

Component B2 used comprises diols or diamines which have, per molecule, an average of 1.8 to 3.0, preferably 2.2 hydrogen atoms that have Zerevitinov activity, and which have a molar mass of from 60 to 400 g/mol, preferably aliphatic diols having from 2 to 14 carbon atoms, e.g. ethanediol, 1,6-hexanediol, diethylene glycol, dipropylene glycol and in particular 1,4-butanediol. However, other suitable compounds are diesters of terephthalic acid with glycols having from 2 to 4 carbon atoms, e.g. bis(ethylene glycol) terephthalate or bis(1,4-butanediol) terephthalate, hydroxyalkylene ethers of hydroquinone, e.g. 1,4-di(β-hydroxyethyl)hydroquinone, ethoxylated bisphenols, e.g. 1,4-di(β-hydroxyethyl)bisphenol A, (cyclo)aliphatic diamines, e.g. isophoronediamine, ethylenediamine, 1,2-propylenediamine, 1,3-propylenediamine, N-methylpropylene-1,3-diamine, and N,N′-dimethylethylenediamine, and aromatic diamines, e.g. 2,4-tolylenediamine and 2,6-tolylenediamine, 3,5-diethyl-2,4-tolylenediamine and/or 3,5-diethyl-2,6-tolylenediamine, and primary mono-, di-, tri- and/or tetraalkyl-substituted 4,4′-diaminodiphenylmethanes. It is also possible to use a mixture of the abovementioned chain extenders. It is also possible to add relatively small amounts of triols. It is also possible to use small amounts of conventional monofunctional compounds, e.g. as chain terminators or mould-release aids. Examples that may be mentioned are alcohols, such as octanol and stearyl alcohol, or amines, such as butylamine and stearylamine.

To produce the TPUs, the amounts reacted of the structural components, if appropriate in the presence of catalysts, of auxiliaries and/or of additives, can preferably be such that the equivalence ratio of NCO groups A to the entirety of the NCO-reactive groups, in particular of the OH groups, of the low-molecular-weight diols/triols B2 and polyols B1, is from 0.9:1.0 to 1.1:1.0, preferably from 0.95:1.0 to 1.10:1.0.

Suitable catalysts according to the invention are the tertiary amines that are conventional and known in the prior art, examples being triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organometallic compounds, such as titanic esters, iron compounds, tin compounds, e.g. tin diacetate, tin dioctoate, tin dilaurate or the dialkyltin salts of aliphatic carboxylic acids, e.g. dibutyltin diacetate, dibutyltin dilaurate or the like. Preferred catalysts are organometallic compounds, in particular titanic esters, iron compounds and/or tin compounds.

Alongside the TPU components and the catalysts, it is also possible to add auxiliaries and/or additives C in amounts of up to 20% by weight, based on the total amount of TPU. They can be predissolved in one of the TPU components, preferably in component B1, or else, if appropriate, can be added in a downstream mixing assembly, e.g. an extruder, after the reaction has taken place. Examples that may be mentioned are lubricants, such as fatty acid esters, metal soaps of these, fatty acid amides, fatty acid ester amides and silicone compounds, antiblocking agents, inhibitors, stabilizers to counter hydrolysis, light, heat and discoloration, flame retardants, dyes, pigments, inorganic and/or organic fillers and reinforcing agents. Reinforcing agents are in particular fibrous reinforcing agents, e.g. inorganic fibres, which are prepared in accordance with the prior art and can also have been treated with a size. Further details concerning the auxiliaries and additives mentioned can be found in the technical literature, for example in the monograph by J. H. Saunders and K. C. Frisch “High Polymers”, Volume XVI, Polyurethane, Parts 1 and 2, Verlag Interscience Publishers 1962 or 1964, or in Taschenbuch fur Kunststoff-Additive [Plastics Additives Handbook] by R. Gachter and H. Müller (Hanser Verlag, Munich 1990), or in DE-A 29 01 774.

Other additives that can be incorporated into the TPU are thermoplastics, such as polycarbonates and acrylonitrile/butadiene/styrene terpolymers, in particular ABS. It is also possible to use other elastomers, such as rubber, ethylene/vinyl acetate copolymers, styrene/butadiene copolymers, and also other TPUs. Other materials suitable for incorporation are commercially available plasticizers, such as phosphates, phthalates, adipates, sebacates and esters of alkylsulphonic acids.

The return, according to the invention, of a portion of the reaction mixture via a circuit to the ingoing end of the mixing apparatus provides the possibility of varying mixing conditions by means of variation of the return volume flow rate \dot{V}_{R}.

Surprisingly, it has been found that the catalyst concentrations required to achieve adequate conversion are smaller than in the case of mixing with no return.

As an alternative, the process can be used to achieve a shorter residence time or a lower reaction temperature than without return, for, in essence, complete conversion.

The partial return moreover provides a novel control method for compensating differences in the reactivity of raw materials by way of the return flow feed and/or the temperature of the returned material. Reactivity of raw materials is particularly important for the industrial production of TPUs, since there is a need to manage differences in the activities of raw materials.

The TPU produced by the process according to the invention can be processed to give injection mouldings, and extruded items, and in particular to give readily softenable foils, to give coating compositions or to give sinter grades and to give readily fusible coextrusion grades, e.g. lamination grades, calandaring grades and powder/slush grades. A particular feature of the material, associated with good homogeneity, is that it, and the mouldings produced therefrom, has a low softening point.

The figures and examples below will be used for further explanation of the invention, but the invention is not restricted thereto.

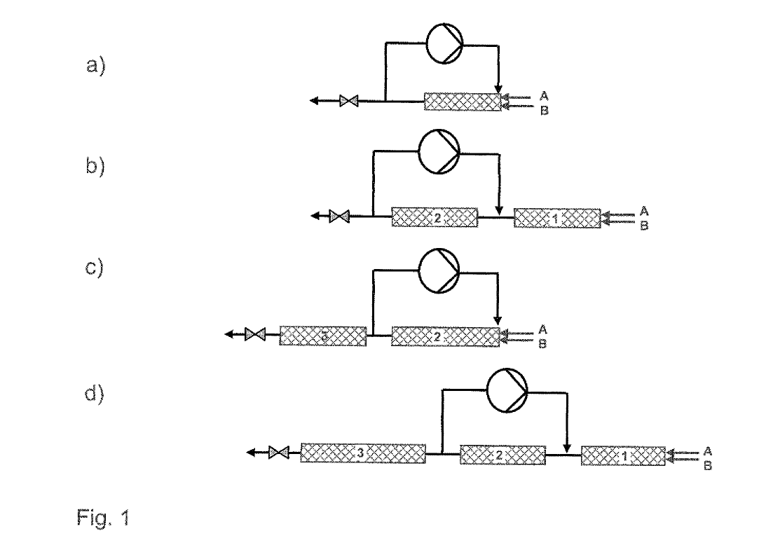

FIGS. 1 to 3 show various apparatuses for carrying out the process according to the invention.

FIGS. 1a) to 1d) show various variants of an apparatus for producing thermoplastic polyurethanes (TPUs) from a premixed mixture B (composed of polyol component B1 and chain extender B2) with isocyanate component A (One-Shot process).

FIG. 1a) shows a recycle reactor with return of a portion of the reaction mixture to the ingoing end of the mixer. Upstream of product discharge at the end of the reactor, there is a throttle valve attached, and this ensures that liquid fills the circulating pump.

FIG. 1b) shows a recycle reactor with a premixer (1) and, located within the circuit, a mixer (2), and also return of a portion of the reaction mixture to a site between premixer (1) and mixer (2). A valve has been attached upstream of product discharge, as in FIG. 1a).

FIG. 1c) shows a recycle reactor with a mixer (2) located within the circuit and with an aftermixer (3), and also return of a portion of the reaction mixture to the ingoing end of the mixer (2). There is a throttle valve attached upstream of product discharge.

FIG. 1d) shows a recycle reactor with a mixture (2) located within the circuit, and with a premixer (1) and with an aftermixer (3), and also return of a portion of the reaction mixture to a site between premixer (1) and mixer (2). There is a throttle valve attached upstream of product discharge.

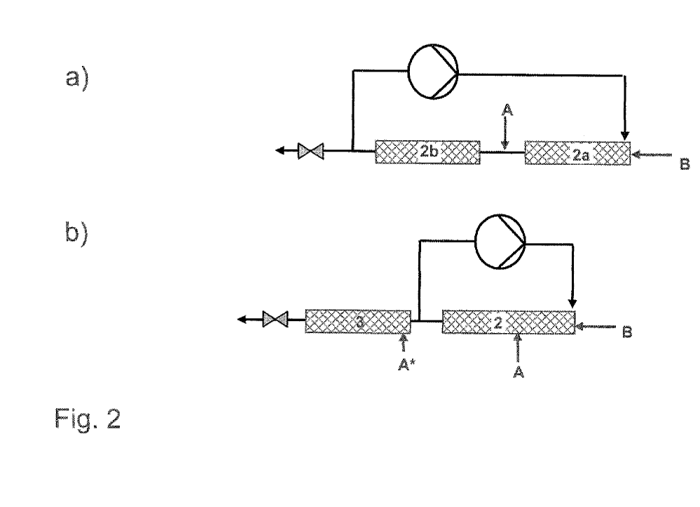

FIGS. 2a) and 2b) show various variants of an apparatus for producing thermoplastic polyurethanes (TPUs) with staged addition of isocyanate component A.

FIG. 2a) shows a recycle reactor where component B is mixed in the form of mixture of B1 and B2 with a portion of the returned reaction mixture in a mixer (2a) located within the circuit. The said mixture is mixed in a downstream mixer (2b) within the circuit with isocyanate component A. There is a throttle valve attached at the end of the recycle reactor.

FIG. 2b) shows a recycle reactor where component B is mixed in the form of mixture of B1 and B2 with a portion of the returned reaction mixture in the recycle mixer (2). The said mixture is mixed with a portion of isocyanate component A at another site in the mixer (2) within the recycle reactor. Downstream of the circuit there is an aftermixer (3), where a further isocyanate component A* is added. There is a throttle valve attached upstream of the outgoing end of the recycle reactor.

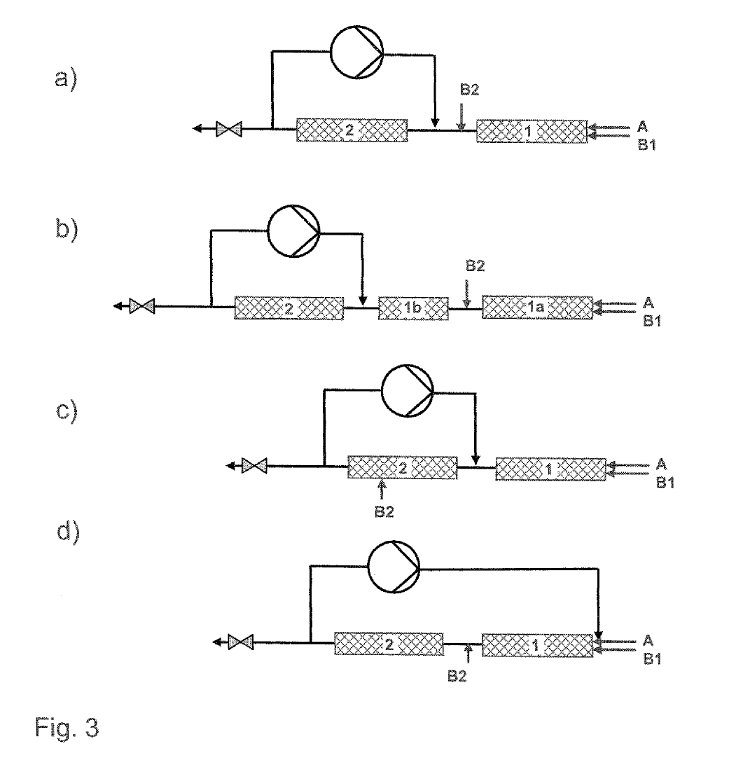

FIGS. 3a) to 3d) show various variants of an apparatus for producing thermoplastic polyurethanes (TPUs) without premixing of polyol component B1 and of chain extender B2 (prepolymer process).

FIG. 3a) shows a recycle reactor with a premixer (1) for producing the prepolymer made of polyol (B1) and isocyanate component (A) and with a mixer (2) within the circuit for mixing to incorporate the chain extender (B2), and also return of a portion of the reaction mixture to a site between premixer (1) and recycle mixer (2). There is a throttle valve attached upstream of product discharge.

FIG. 3b) shows a recycle reactor with a premixer (1a) for producing the prepolymer made of polyol (B1) and isocyanate component (A) and with a second premixer (1b) for mixing to incorporate the chain extender (B2). The said mixture is further reacted in a recycle mixer (2) within the circuit. There is a throttle valve attached upstream of product discharge.

FIG. 3c) shows a recycle reactor with a premixer (1) for producing the prepolymer made of polyol (B1) and of isocyanate component (A). The prepolymer then passes through the recycle mixer (2). The chain extender (B2) is added at a site in the recycle mixer (2). The said mixture is further reacted within the recycle mixer. There is a throttle valve attached upstream of product discharge.

FIG. 3d) shows a recycle reactor with two recycle mixers (1 and 2). Upstream of the first mixer (1), the polyol (B1) and isocyanate component (A) are metered into the system together with the returned volume. After the premixing process within the recycle mixer (1), the chain extender (B2) is added upstream of the mixer (2) and reacts within recycle mixer (2).

### EXAMPLE 1

### Example According to the Invention

The recycle reactor used comprised an arrangement of static mixers arranged in series by analogy with the diagram in FIG. 1c). The mixer (2) within the pumped circulation system was composed of a cascade of 2 cascade mixers each of diameter D=6 mm and length L_{SMX}=30 mm, i.e. with a total length L=60 mm The outlet mixer (3) was composed of two SMX mixers each of diameter D=6 mm and length L_{SMX}=30 mm, i.e. with total length L=60 mm (see Table 1).

The following were added separately from one another: 3395 g/h of a mixture of polyol (PE 90 B=polybutylene adipate, average molar mass Mn=950 g/mol) which comprised 30 ppm, based on Ti metal concentration, of an organic titanate catalyst (Tyzor solution, DuPont), and 1,4-butanediol, in a polyol:butanediol ratio by weight of 7.42: 1, and also 1860 g/h of 4,4-MDI. The temperature of the MDI and of the polyol/butanediol mixture was respectively 200 (+/−10° C.). The components were mixed in an all-round-heated arrangement of the mixers listed in Table 1. D here means diameter, L means total length, and V means total volume. The recycle ratio f was varied from 2.6 to 3.6.

This process could produce TPU for a period of more than 120 min without any pressure rise observed prior to the static-mixer cascade.

### EXAMPLE 2

### Comparison by Analogy with EP1055691B1

The above polyester butanediol mixture of Example 1 was added continuously to a SMX static mixer from Sulzer (for dimensions see Table 2).

Diphenylmethane 4,4′-diisocyanate was simultaneously pumped continuously, as in Example 1, into the static mixer.

The resultant TPU was directly added to the first feed point (barrel section 1) of an extruder (ZSK 83 from Werner/Pfleiderer). The ethylene bisstearylamide was added to the same barrel section. The hot melt was drawn off as strand at the end of the extruder, cooled in a water bath and pelletized.

### EXAMPLE 3

### Production of Injection Mouldings from the TPUs of Examples 1 to 3

The respective TPU pellets from Examples 1 to 2 were melted in a D 60 injection-moulding machine from Mannesmann (32-series screw) (melt temperature about 225° C.) and moulded to give plaques (125 mm×50 mm×2 mm)

### EXAMPLE 4

### Temperature-Related Dynamic-Mechanical Analysis (DMA)

Taking each of the injection-moulded specimens from Example 3, a test specimen (50 mm×12 mm×2 mm) stamped out from the injection-moulded plaque was used for a temperature-related dynamic-mechanical measurement in the torsion pendulum test by analogy with DIN 53 445.

The measurements were made using a DMS6100 from Seiko at 1 Hz in the temperature range from −125° C. to 250° C. with a heating rate of 2° C./min. The softening behaviour according to the invention is characterized by stating, in Table 3, the glass transition temperature TG, the modulus at 20° C. and the temperature at which the storage modulus E′ reaches the value 2 MPa (the softening point).

TABLE 1
Arrangement of recycle reactor by analogy
with FIG. 1c (see Example 1)

| | Diameter D | Length L | Volume |
|---|---|---|---|
| Unit | [mm] | [mm] | [mL] |
| SMX mixer 2 | 6 | 60 | 1.4 |
| Recycle pump | — | — | 13.3 |
| Pump lines to/from pump | 4 | 20 | 0.2 |
| SMX mixer 3 | 6 | 60 | 1.4 |

TABLE 2
Dimensions of two-stage static mixer (see Example 2)

| | Mixer length | Mixer diameter | Shear rate | Residence time |
|---|---|---|---|---|
| Mixer | [mm] | [mm] | [s−1] | [s] |
| DN 20 | 390 | 19 | 1400 | 1 |
| DN 70 | 700 | 70 | 70 | 10 |

TABLE 3
Properties of test specimens (see Example 4)

| Specimen of | | | | |
|---|---|---|---|---|
| injection moulding | | | | |
| of a material from | Polyol | | DMA E′ | DMA T |
| Example | basis | DMA TG | (20° C.) | (2 MPa) |
| 1 Recycle system | PE 90 B | −20° C. | 59 | 139° C. |
| 2 (Comparison SM) | PE 90 B | −19° C. | 72 | 133° C. |

1. Process for continuously producing thermoplastically processable polyurethane elastomers with improved softening behavior and/or with reduced catalyst content, wherein
a component A which comprises one or more polyisocyanates, and
a component B which has hydrogen atoms that have Zerevitinov activity and which comprises
B1: from 1 to 85 equivalent%, based on the isocyanate groups in A, of one or more compounds which have, per molecule, at least one 1.8 and at most 2.2 hydrogen atoms that have Zerevitinov activity, and which have an average molar mass M̅ₙ of from 450 to 5000 g/mol, and
B2: from 15 to 99 equivalent %, based on the isocyanate groups in A, of one or more chain extenders which have, per molecule, at least one 1.8 and at most 2.2 hydrogen atoms that have Zerevitinov activity, and which have a molar mass of from 60 to 400 g/mol,
and also from 0 to 20% by weight, based on the total amount of TPU, of further auxiliaries and additives C,
where the NCO/OH ratio of components A and B used is from 0.9:1 to 1.1:1,
are reacted in a recycle reactor, wherein the recycle reactor comprises at least one inlet, one mixing apparatus, one outlet, and means for returning a portion of the reaction mixture from the outgoing end of the mixing apparatus to the ingoing end of the mixing apparatus.

2. Process according to claim 1, wherein the mixing apparatus is a static mixer or an arrangement of static mixers.

3. Process according to claim 1, wherein the recycle ratio f of the circuit is in the range from 1 to 150, where
$$f = \frac{( {\dot{V}}_{R} + {\dot{V}}_{tot} )}{{\dot{V}}_{tot}}$$
where \dot{V}ₜₒₜ=\dot{V}_{A}+\dot{V}_{B}+\dot{V}_{C} is the total of all of the volume flow rates of the starting materials A, B and C, and \dot{V}_{R} is the return volume flow rate.

4. Process according to claim 2, wherein the shear rate within the recycle reactor can be varied during operation via alteration of the recycle ratio.

5. Process according to claim 2, wherein the static mixers used in the circuit produce, during operation of the recycle reactor, shear rates at the walls thereof in the range from 100 s⁻¹ to 50 000 s⁻¹.

6. Process according to claim 2, wherein the residence time in the static mixers used in the circuit is in the range from 0.1 s to 30 s.

7. Process according to claim 2, wherein the static mixers used in the circuit are of thermally insulated design or have been heated to from 200° C. to 280° C.

8. Process according to claim 2, wherein the static mixers used in the circuit have a length/diameter ratio of from 4:1 to 60:1.

9. Process according to claim 1, wherein components A and B are heated separately from one another to a temperature of from 170° C. to 250° C., and are fed simultaneously and continuously in liquid form into a first static mixer which is within the circuit or has been installed upstream of the same, where B is a mixture made of B1 and B2.

10. Process according to claim 1, wherein components A and B1 are first heated separately from one another to a temperature of from 170° C. to 250° C., and are fed simultaneously and continuously in liquid form into a first static mixer, and component B2 is heated in the same way and added at another site to the reacting mixture of A and B1.

11. Process according to claim 1, wherein component A comprises diphenylmethane diisocyanate isomer mixtures having more than 96% by weight diphenylmethane 4,4′-diisocyanate content.

12. Process according to claim 1, wherein component B1 comprises polyester diols, polyether diols, polycarbonate diols, or a mixture thereof.

13. Process according to claim 1, wherein no catalyst is added.

14. The process of claim 3, wherein said recycle ratio f is in the range from 1.2 to 50.

15. The process of claim 14, wherein said recycle ratio f is in the range from 1.3 to 20.

16. The process of claim 15, wherein said recycle ratio f is in the range from 1.4 to 8.
